(19) United States
(12) Patent Application Publication
(10) Pub. No.: US 2014/0088750 A1
(43) Pub. Date: Mar. 27, 2014

(54) SYSTEMS, METHODS AND PROCESSES FOR MASS AND EFFICIENT PRODUCTION, DISTRIBUTION AND/OR CUSTOMIZATION OF ONE OR MORE ARTICLES

(71) Applicant: Kloneworld Pte. Ltd., Singapore (SG)

(72) Inventors: Ajay Sharma, Caribbean at Keppel Bay (SG); Gurjit Singh Sidhu, Dunearn Lodge (SG)

(73) Assignee: Kloneworld Pte. Ltd., Singapore (SG)

(21) Appl. No.: 14/028,649

(22) Filed: Sep. 17, 2013

Related U.S. Application Data
(60) Provisional application No. 61/704,035, filed on Sep. 21, 2012.
(60) Provisional application No. 61/714,314, filed on Oct. 16, 2012.

(51) Int. Cl. G05B 19/4099

(52) U.S. Cl. CPC G05B 19/4099
USPC 700/118

(57) ABSTRACT

A system, method and/or process provide mass and efficient production, customization and/or distribution of one or more customized items in digital or physical form. A 2D image of a user may be utilized to create a plurality of 2D images or 3D models of the user having a plurality of facial expressions. One or more of the 2D images or 3D models of the user may be added to or incorporated into an original article to create and/or generate a customized item which includes the user. The 2D images or 3D models of the user may be inserted into one or more original frames of the original article to produce one or more customized frames which may be joined or added to the original article to generate the customized article.

### CROSS REFERENCE TO RELATED APPLICATION

This application claims the benefit of U.S. Provisional Patent Application Nos. 61/704,035, filed Sep. 21, 2012, and 61/714,314, filed Oct. 16, 2012, the entirety of these application which is hereby incorporated by reference into this application.

### FIELD OF THE DISCLOSURE

The present disclosure relates generally to systems, methods and/or processes for mass and efficient production, distribution and/or customization of one or more vanity and/or customizable articles in digital form and/or in physical form.

### SUMMARY OF THE DISCLOSURE

The present systems, methods and processes may provide for mass and efficient production, distribution and/or customization of one or more vanity and/or customizable articles in an inexpensive and timely manner.

In an embodiment, the present systems, methods and/or processes may execute, perform, carry out and/or include one or more steps of: obtaining a 2-dimensional digital image or photograph (hereinafter “2D image”) of a user; uploading the obtained image into at least one computer and/or digital system (hereinafter “the computer”); converting of the obtained image to 3-dimensional (hereinafter “3D”) model via one or more computer programs and/or software; customizing the 3D model according to one or more unique user codes assigned by the computer and/or the digital system and/or the one or more computer programs and/or software; producing at least one vanity article and/or at least one customized article in digital form and/or physical form; and distributing the produced vanity article and/or customized article to the user and/or to a third party.

In embodiments, the present systems, methods and/or processes may execute, perform, carry out and/or include one or more steps of capturing, obtaining and/or accessing at least one 2D image of a user having a first facial expression, such as, for example a natural and/or neutral facial expression. The at least one 2D image may include a background and/or foreground which may be located behind, in front of and/or adjacent to the user.

In embodiments, the present systems, methods and/or processes may execute, perform and/or include at least one step of: generating and/or creating, via the one or more computer programs and/or software, one or more 2D images and/or 3D models of the user having a plurality of second facial expressions (hereinafter “second expressions”) of the user based on the at least one 2D image of the user having the first facial expression; converting, via the one or more computer programs and/or software, the at least one 2D image to at least one 3D model of the user and animating and/or manipulating the 3D model to generate and/or create one or more 2D images and/or 3D models of the user having and/or expressing one or more second facial expressions of the user; and producing, drawing or sketching the second expressions of the user and/or uploading the second expressions into the at least one computer and/or digital system.

In embodiments, the present systems, methods and/or processes may execute, perform and/or include a step of uploading and/or entering at least one 2D image of the user to and/or into the at least one computer, wherein the at least one computer may automatically convert the at least one 2D image to the at least one 3D image and/or generate and/or create the one or more 2D images and/or 3D models of the user having and/or expressing one or more of the second expressions.

In embodiments, the present systems, methods and/or processes may execute, perform, carry out and/or include at least one step of: providing, producing and/or generating an original vanity article and/or an original customizable article (hereinafter “original article”); and providing, producing and/or generating the customized original article (hereinafter “customized article”) by including and/or incorporating one or more of the one or more 2D images and/or 3D models of the user having and/or expressing the second expressions into the original article.

In embodiments, the present systems, methods and/or processes may execute, perform and/or include a step of customizing one or more frames that may be included in the original article to produce, generate and/or create the customized article and/or one or more customized frames for the customized article. In embodiments, the customized frames for customizing the original article may be one or more transferrable items, such as, for example, an adhesive items which may be physically adhered, connected and/or attached to the original article to produce the customized item.

In embodiments, the present systems, methods and process may execute, perform, carry out and/or include at least one step of: assign at least one unique user code to each second facial expression of the second expressions of the user; assign at least one unique article code to each original article before or after customization of the original article to obtain, generate and/or create the customized article; and adding, inserting and/or including at least one printed indicia, which may be associated with the user and/or a third party, onto and/or into the original article to generate, create and/or obtain the customized article and/or to customize the original article.

In yet another embodiment, the present systems, methods and processes may provide access to and/or distribute the customized article and/or the customizable original article, in digital form and/or physical form, to the user and/or a third party, to the at least one computer, to one or more other digital device, such as, for example, a portable digital device and/or a digital handheld device and/or to one or more peripheral device for printing, producing, creating and/or manufacturing the one or more customized frames.

In embodiments, a method may customize at least one original article and/or may distribute at least one customized article. The method may obtaining, via a first computer, at least one 2-dimensional image of at least one user, converting the at least one 2-dimensional image to at least one 3-dimensional model of the at least one user, modifying the at least one original article with the at least one 3-dimensional model of the at least one user to produce the at least one customized article, wherein the at least one customized article incorporates the at least one converted 3-dimensional model therein, and/or printing and distributing the at least one customized article via at least one 3-dimensional printer.

In an embodiment, at least one 2-dimensional image of the at least one user may comprise at least one first facial expression of the at least one user, and further wherein the at least one 3-dimensional model of the at least one user may comprise at least one second facial expression of the at least one user, wherein the at least one second facial expression may be a different facial expression than the at least one first facial expression of the at least one user.

In an embodiment, the customized article may be a 3-dimensional printed article, sculpture or model.

In an embodiment, the obtaining the at least one 2-dimensional image of the at least one user further may comprise uploading the at least one 2-dimensional image of the at least one user to the first computer.

In an embodiment, the at least one 2-dimensional image of the at least one user may be uploadable to the first computer from an online website, a mobile phone, a digital camera, a handheld digital device, a portable digital device or a laser scanner.

In an embodiment, the at least one 2-dimensional image of the at least one user may include at least one of a background and a foreground, and further wherein the at least one customized article includes one or more of the background and the foreground.

In an embodiment, the converting the at least one 2-dimensional image of the at least one user to at least one 3-dimensional model of the at least one user may be performed by a central processing unit that may be located remote with respect to the first computer and the at least one user.

In embodiments, a method may customize at least one original article and/or may distribute at least one customized article. The method may obtaining, via a first computer, a first 2-dimensional image of at least one user comprising at least one of a first facial expression and a first facial view, generating a plurality of second 2-dimensional images or 3-dimensional models of the at least one user based on the first 2-dimensional image of the at least one user, wherein the plurality of second 2-dimensional images or 3-dimensional models may comprise at least one of a plurality of second facial expressions of the at least one user and a plurality of second facial views of the at least one user, generating the at least one customized article by modifying the at least one original article to include at least one 2-dimensional image of the generated plurality of second 2-dimensional images or at least one 3-dimensional image of the generated plurality of 3-dimensional models, and/or distributing the at least one customized article in digital form or in physical form.

In an embodiment, the at least one customized article, in digital form, may be selected from the group consisting of a digital story book or movie, a digital animation film, a digital video game, and a digital comic book, wherein the at least one customized article may be displayable via a digital display associated with the first computer.

In an embodiment, the at least one customized article, in physical form, may be selected from the group consisting of a story book, a sticker book or album, an illustrated book, and a board game, wherein the at least one customized article may be printable via a printer associated with the first computer.

In an embodiment, the at least one customized article, in physical form, may consist of a 3-dimensional printed article selected from the group consisting of a sculpture, a model and a vanity collectible.

In an embodiment, the generating the plurality of 2-dimensional images or 3-dimensional models of the at least one user further may comprise executing one or more computer programs or software that convert the first 2-dimensional image of the at least one user into the plurality of generated second 2-dimensional images or the plurality of generated 3-dimensional models.

In an embodiment, the one or more computer programs or software may be stored within the first computer, within a second computer in communication with the first computer via a digital network or within a database accessible via a server and the digital network.

In an embodiment, the at least one customized item may comprise one or more customized frames, wherein one or more original frames of the at least one original article may be modified with the at least one 2-dimensional image of the generated plurality of second 2-dimensional images or the at least one 3-dimensional image of the generated plurality of 3-dimensional models to produce the one or more customized frames.

In an embodiment, the one or more customized frames may comprise one or more transferrable images.

In an embodiment, the one or more transferrable images may be one or more adhesive stickers and the at least one original article is a sticker book.

In embodiments, a non-transitory computer-readable storage medium may store one or more computer programs which may enable a computer system, after the program is loaded into memory of the computer system, to execute a process for customizing at least one original article and/or distributing at least one customized article. The process may obtaining a first 2-dimensional image of a user via the computer system, wherein the first 2-dimensional image of the user may comprise at least one of a first facial expression and a first facial view, generating a plurality of second 2-dimensional images of the at least one user based on the first 2-dimensional image of the at least one user, wherein the plurality of second 2-dimensional images may comprise at least one of a plurality of second facial expressions of the at least one user and a plurality of second facial views of the at least one user, modifying one or more original frames of the at least one original article with one or more 2-dimensional images of the plurality of generated second 2-dimensional images to produce one or more customized frames, wherein the one or more customized frames may comprise one or more transferrable images displaying the one or more 2-dimensional images of the generated plurality of generated second 2-dimensional images of the user, and/or distributing the one or more customized frames via a printer associated with the computer system.

In an embodiment, the one or more transferrable images may comprise one or more adhesive stickers and the original article may be a sticker book

In an embodiment, the obtaining the first 2-dimensional image of the at least one user further may comprise uploading the first 2-dimensional image of the at least one user to a first computer of the computer system.

In an embodiment, the plurality of generated second 2-dimensional images of the user may be created from one or more 3-dimensional models of the at least one user that are based on the first 2-dimensional image of the at least one user.

### BRIEF DESCRIPTION OF THE DRAWINGS

So that the features and advantages of the present disclosure can be understood in detail, a more particular description of the system, method and process, may be had by reference to the embodiments thereof that are illustrated in the appended drawings. It is to be noted, however, that the appended drawings illustrate some embodiments of the present system, method and process and are therefore not to be considered limiting of its scope, for the system, method and process may admit to other equally effective embodiments.

FIG. 1 illustrates a flowchart of a process for producing a 3-dimensional model in accordance with an embodiment.

FIG. 2 illustrates a flowchart for customizing a 3-dimensional model in accordance with an embodiment.

FIG. 3 illustrates a flowchart for printing and delivery of a 3-dimensional prototype model in accordance with an embodiment.

FIG. 4 illustrates a system for generating a customized article in accordance with an embodiment.

FIG. 5 illustrates a method or process for generating and distributing a customized article in accordance with an embodiment.

FIG. 6 illustrates a plan view of an array of 2D images of a user having a plurality of facial expressions in accordance with an embodiment.

FIG. 7 illustrates a plurality of hand sketched images of a user for uploading and creating a customized article in accordance with an embodiment.

FIG. 8 illustrates a customized article, in digital story book form, including images of the user in accordance with an embodiment.

FIG. 9 illustrates a schematic diagram for customizing an original article in accordance with an embodiment.

FIG. 10 illustrates, in front plan view, customized frames for customizing an original article in accordance with an embodiment.

FIG. 11 illustrates, in front plan view, original articles for customizing with customized frames in accordance with an embodiment.

FIG. 12 illustrates, in front plan view, a photo of a user for creating and/or generating one or more customized frames based on the photo of the user in accordance with an embodiment.

FIG. 13 illustrates, in front plan view, customized frames for customizing an original article in accordance with an embodiment.

FIG. 14 illustrates, in front plan view, a peripheral device for producing, creating, generating and/or manufacturing one or more customized frames for customizing an original article in accordance with an embodiment.

FIG. 15 illustrates, in front plan view, at least one customized frame for customizing an original article in accordance with an embodiment.

FIG. 16 illustrates, in front plan view, a customized frame for including onto an original article to create a customized article in accordance with an embodiment.

### DETAILED DESCRIPTION

The present disclosure relates to systems, methods and processes for mass and efficient production, distribution and/or customization of one or more customized vanity articles and/or customized original articles (hereinafter “customized articles”). The customized articles may be one or more articles which may be in digital form and/or in physical form. The customized articles include, for example, one or more 3D printed articles and/or sculptures (hereinafter “3D articles”) which may relate to at least one of, for example, vanity collectibles, concept models, original articles and/or the like. The customized articles and/or the original articles may be one or more 2D articles and/or one or more 3D articles which may include, for example, a physical or digital story book or movie, a sticker book, a sticker album, a digital or video game, a digital or video animation, a physical book, a board game, a physical or digital comic book, an animation film and/or the like. The present disclosure should not be deemed as limited to a specific embodiment of customized articles, the 3D articles, and/or the original articles.

The present system, method and/or process may utilize and/or execute one or more 3-dimensional model or image generating technologies (hereinafter “3D generating technologies”) to produce, distribute and/or customize the one or more original articles to obtain, create and/or generate one or more customized articles. The 3D generating technologies may include, for example, 2-dimensional to 3-dimensional converter technology, 3-dimensional rapid printing technology and/or 3-dimensional face reconstruction from 2-dimensional images technology. As a result of utilizing the 3D generating technologies, the present systems, methods and/or processes may provide more efficient, less expensive and faster means for obtaining, creating and/or generating the one or more customized articles from the one or more original articles. The present disclosure should not be deemed as limited to a specific embodiment of 3D generating technologies which may be utilized with the present systems, methods and processes.

At least one 2D image (hereinafter “the 2D image”) of the user may be obtained, captured, accessed and utilized by the present systems, methods and/or processes for making at least one 3D model of the user. In embodiments, the user may be a person, such as, for example, a child, a parent and/or relative of the child, a teenager, an adult or an elderly person. In embodiments, the user may, locally, upload and/or provide the 2D image of the user to the at least one computer or access the at least one 2D image of the user from at least one remote database and/or one or more websites via, for example, a web-based server and a digital network, such as the Internet and/or the World Wide Web. It should be understood that the present disclosure is not to be deemed limited to a specific embodiment of the user.

After the at least one 2D image of the user is available to the at least one computer, the at least one 2D image may be transformed and converted into the at least one 3D model of the user via one or more computer programs and/or software stored on the at least computer, one or more computer programs and/or software stored on at least one remote computer, or a combination therein. The one or more programs and/or software may be stored and/or storable on one or more non-transitory computer-readable storage devices and/or mediums. The one or more computer programs and/or software may include one or more instructions for executing, performing and/or carrying out one or more steps of the present methods and/or processes. The one or more non-transitory computer-readable storage devices and/or mediums may have encoded thereon the one or more instructions associated with the one or more computer programs and/or software, which, when executed by at least one processor associated with the at least one computer and/or the at least one remote computer, may execute, perform and/or carry out one or more steps of the present methods and/or processes. The one or more non-transitory computer-readable storage devices and/or mediums may store the one or more computer programs and/or software which may enable the at least one computer and/or the at least one remote computer, after the one or more computer programs and/or software may be loaded into a memory of the at least one computer and/or the at least one remote computer, to execute, perform and/or carry out one or more steps of the present methods and/or processes. In embodiments, at least a non-transitory part of the one or more computer programs and/or software may be embodied in at least one or more program modules which may be installed on the at least one computer and/or the at least one remote computer. In embodiments, the at least one or more program modules may be a plug-in for the at least one computer and/or the at least one remote computer.

The at least one computer and/or the at least one remote computer (hereinafter “the computer and/or remote computer”) may executed the one or more instructions and/or the one or more computer programs and/or software which may generate, create and provide the one or more 2D images and/or 3D models of the user having the second expressions. The computer and/or the remote computer may assign at least unique user code to each of the one or more 2D images and/or 3D models, wherein the user code may be representative of and/or may be associated with the second facial expression of the user that may be contained within each of the one or more 2D images and/or 3D models.

The present systems, methods and/or processes may customize the original article to generate, create and/or produce the customized article via one or more instructions and/or the one or more computer programs and/or software which may be executed by stored the computer, the remote computer or a combination therein. The customized article may include and/or incorporate one or more 2D images and/or 3D images selected from the plurality of 2D images and/or 3D images of the user. As a result, the customized article may include and/or incorporate one or more facial expressions selected the second expressions of user. The instructions and/or the one or more computer programs and/or software executable by the computer and/or the remote computer may determine and selected the 2D images, 3D images and/or second facial expressions of the user which may be included and/or incorporated into the customized article. Moreover, one or more printed indicia indicative of and/or associated with the user and/or a third party may be included, adhered, connected, attached, inserted and/or incorporated onto and/or into the original articles to create, generate and/or produce the customized articles. For example, a first name of the user and/or a third party may be adhered, connected, attached and/or added to the customized articles and/or the original articles. The computer and/or the remote computer may be configured to provide, produce and/or distribute the customized article, in digital form and/or in physical form, to the user and/or the third party.

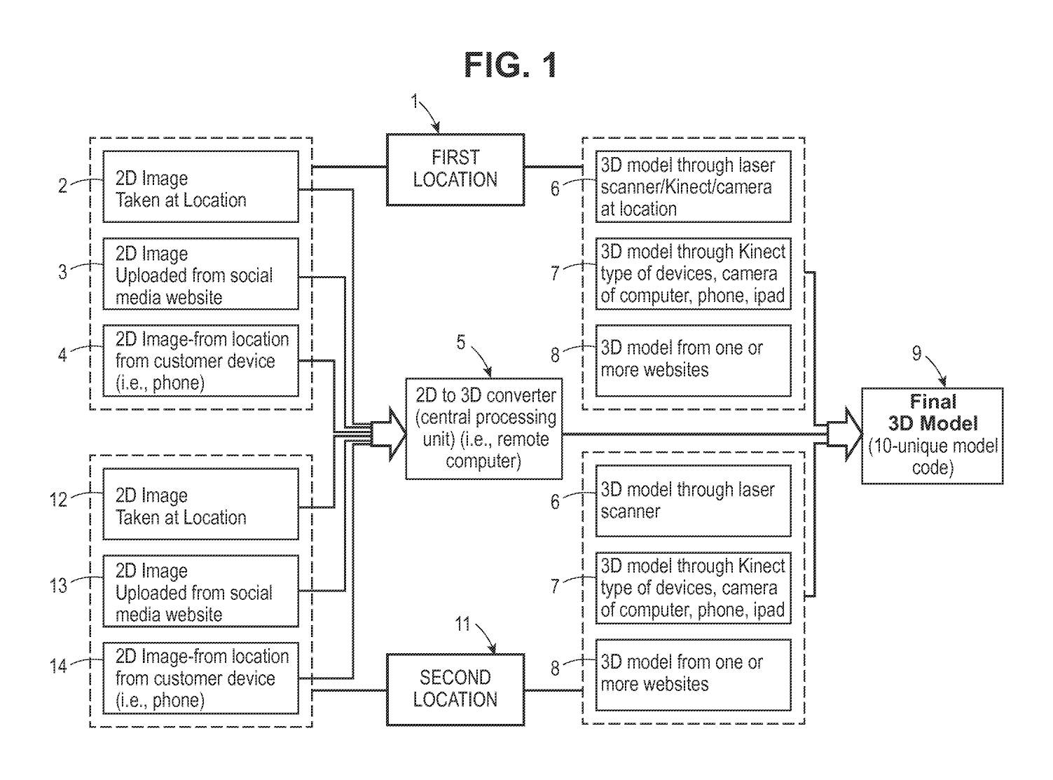

Referring now to the drawings wherein like numerals refer to like parts, FIG. 1 illustrates a process for creating one or more 3D models for one or more customers and/or users (hereinafter “the customer and/or the user”) in an embodiment. For example, the 3D model may be a vanity collectible and/or a customized frame, caricature, cartoon character, or image having a face and/or a body of the one or more of the customers and/or users. The 3D model may be obtained by, for example, conversion of the 2D image of the user into the 3D model of the customer and/or the user or by directly obtaining the 3D model of the face and/or the body of the customer and/or the user. The customer and/or the user may be exhibiting the first facial expression which may be shown in the 2D image and/or the 3D model.

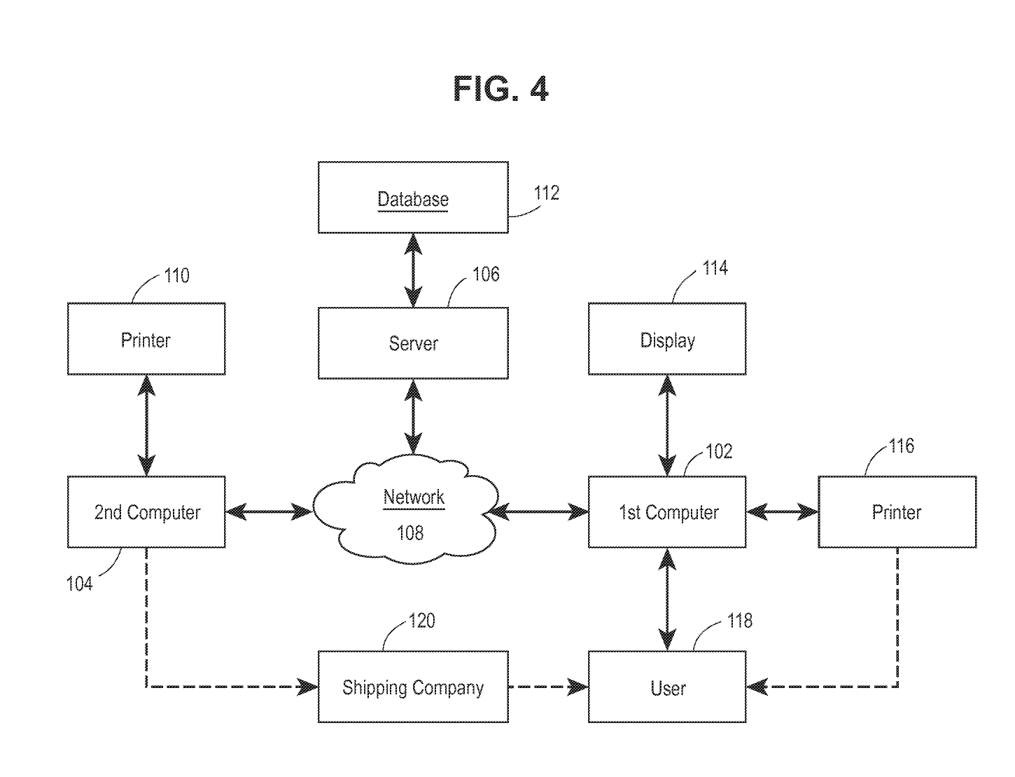

At a first location 1, such as, for example, Singapore, the 2D images from one or more customers may be created, procured and/or obtained by the present systems, methods and/or processes. For example, a first 2D image 2 of a first customer or user may be taken and/or obtained at the first location 1. In an embodiment, a second 2D image 3 of a second customer or user may be uploaded from a website which may be accessible at the first location 1 which may be stored in a server, such as the server 106 (as shown in FIG. 4) which may be located locally or remotely with respect to the first location 1. In an embodiment, a third 2D image 4 of a third customer or user may be a digital photograph uploaded from a customer device which may be located at the first location 1 or a physical photograph scanned and uploaded by the third customer or user at the first location 1. In an embodiment, a customer may, for example, upload a plurality of digital photographs which may be utilized by the present systems, methods and/or processes to create and/or produce one or more 3D models of the customer and/or user.

In another embodiment, at a second location 11, such as, for example, New York, the 2D images from one or more customers and/or users may be created, procured and/or obtained by the present systems, methods and/or processes. For example, a fourth 2D image 12 from a fourth customer or user may be taken and/or obtained at the second location 11. In an embodiment, a fifth 2D image 13 from a fifth customer may be uploaded from, for example, a website which may be accessible at the second location 11 which may be stored on a server located locally or remotely with respect to the second location. In embodiments, the website may be social media website, a photo-sharing website, a media-sharing website and/or the like. In an embodiment, a sixth 2D image 14 from a sixth customer or user may be one or more digital photographs uploaded from a customer device which may be located at the second location 11 or a physical photograph scanned and uploaded by the sixth customer at the second location 11. The one or more digital photographs may be utilized to create one or more 3D models of the sixth customer or user. In embodiments, the customer device may be, for example, a smart phone, laptop computer, cellular phone, digital tablet and/or the like. It should be understood that the present disclosure is not deemed to be limited to a specific embodiment of the first and second locations 1, 11, the website and/or the customer device.

The creation and/or procurement of the 2D images (i.e., first image 2, second image 3, third image 4, fourth image 12, fifth image 13 and/or sixth image 14) may be done simultaneously at, for example, hundreds of locations around the world. The one or more created, procured and/or obtained 2D images may be electronically sent to a Central Processing Unit 5 (hereinafter “CPU 5”) which may include the server, such as, for example, server 106, and/or a processor accessible over a digital network, such as, digital network 108 (as shown in FIG. 4). The location of the CPU 5 may be separate from, independent from and/or remote with respect to the place(s) (i.e., first and second locations 1, 11) where the one or more 2D images may have been created, procured and/or obtained. The one or more 2D images may be converted into one or more 3D models using the above-mentioned technologies via the CPU 5.

In an embodiment, the 3D model may be obtained directly through a 3D model generator 6 which may be located at the first location 1 or the second location 2. In another embodiment, the 3D model may be obtained directly through at least one kinect-type device 7 which may be located at the first location 1 or the second location 2. The 3D model may be selected and/or uploaded from a plurality of 3D models stored on and/or accessible via one or more online websites and/or web-accessible servers and/or databases. The plurality of stored 3D models may be pre-existing and/or updated on a regular basis as known to one skilled in the art. In embodiments, the 3D model generator 6 may be, for example, a laser scanner, the kinect-type device, camera and/or the like. Moreover, the kinect type device 7 may be, for example, a camera, a computer, a laptop computer, a smart phone, a cellular phone and/or a digital tablet. The present disclosure should not be deemed as limited to a specific embodiment of the 3D model generator 6 and/or the kinect type device 7.

The 3D models 9 finalized and based on the converted 2D images created, procured and/or obtained at multiple locations which may be obtained by the present system, method and/or process. Each finalized 3D model 9 may be assigned at least one unique model code 10 as shown in FIG. 1 which may describe one or more requirements and/or attributes associated with the one or more images, such as, for example, age, sex, customization, location, expected time of delivery for the 3D model. The at least one model code 10 may be used for customization, tracking, and/or delivery of the customized article and/or the final 3D model 9.

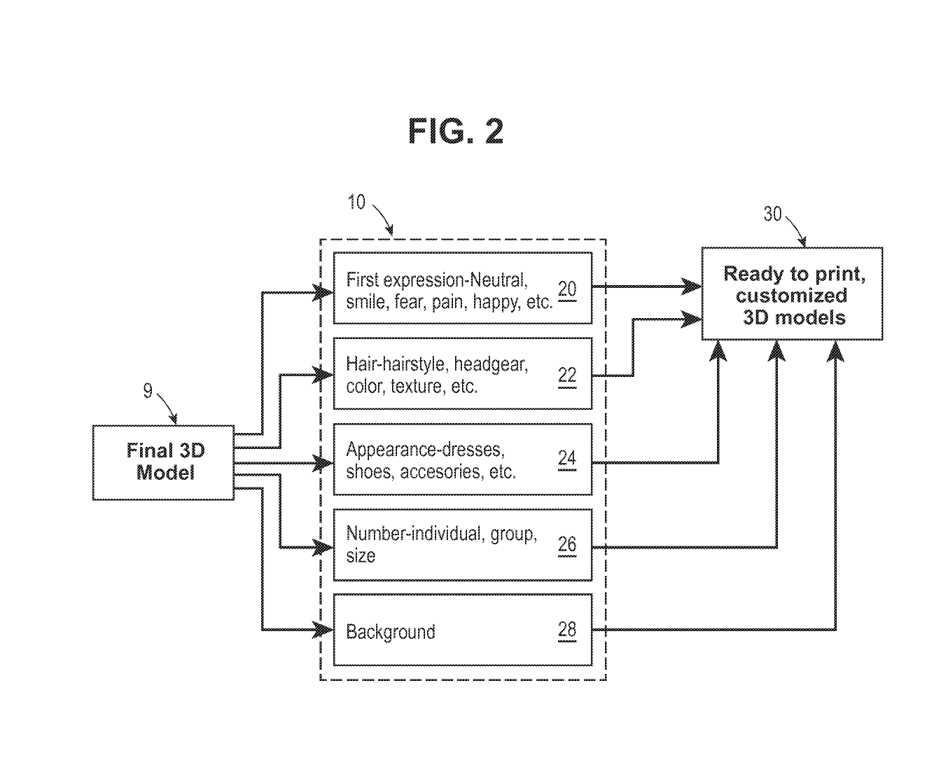

At the CPU 5, the finalized 3D model 9 may be customized with accessories and/or expressions as shown in the flowchart in FIG. 2. For example, the customization of the final 3D model 9 may include for example, the first facial expression 20 (hereinafter “first expression 20”), hair 22, appearance 24, number 26 and/or background 28. The first expression 20 of the customer or user may refer to facial expressions of the customer or user displayed in the finalized 3D model 9, such as, for example, neutral, smile, fear, pain, happy and/or the like. The hair 22 of the customer or user may refer to, for example, hair style, headgear, colour, texture and/or the like. The appearance 24 of the customer or user may refer to, for example, dress, shoe, accessories, eyeglasses and/or the like. The number 26 associated with the finalized 3D model 9 may refer to, for example, individual, family, group size shown, exhibited and/or illustrated in the finalized 3D model 9. The background 28 of the finalized 3D model 9 may refer to the 3D background that may be provided with the final 3D model.

In embodiments, after customization may be completed, one or more final, ready to print, customized 3D models 30 (hereinafter “printable 3D models 30”) may be generated and/or to transmitted to a printing location for 3D printing. The printing location may be the first and/or second locations 1, 11 or may be a third location (not shown in the drawings) which may be local or remote with respect to the first and/or second locations 1, 11 and/or the location of the CPU 5.

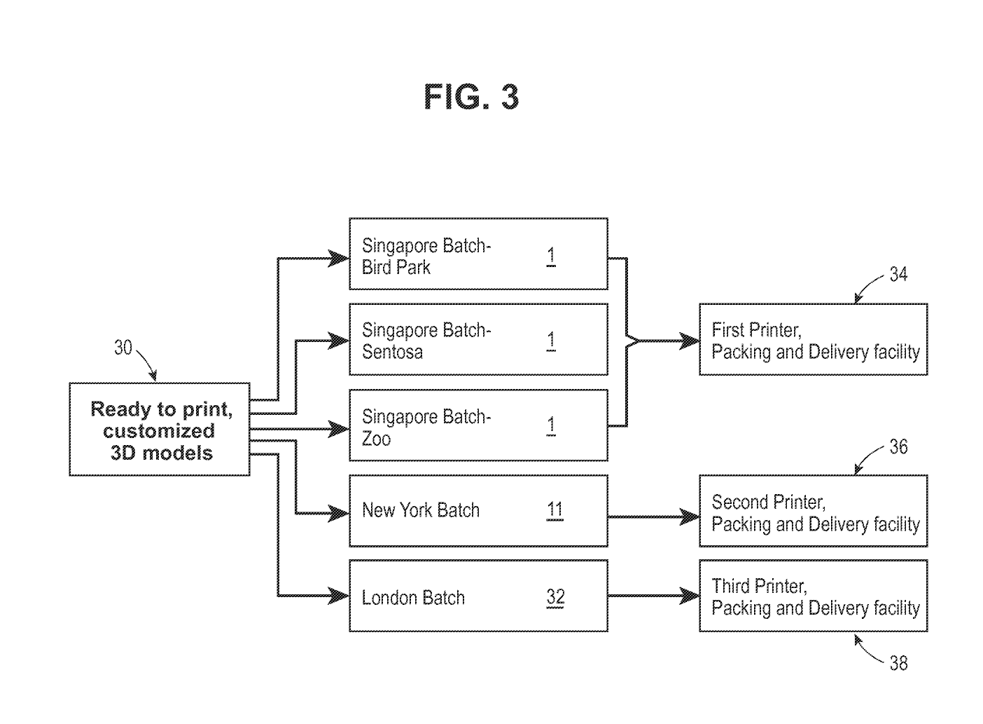

FIG. 3 illustrates a flowchart for one or more subsequent steps in the preparation, printing and/or delivery of the printable 3D models 30. The printable 3D models 30 may be created, produced, printed and/or generated locally with respect to the CPU 5 (shown in FIGS. 1 and 2). Depending on the one or more unique model codes 10 generated and/or assigned by the CPU 5 in FIG. 1, one or more of the printable 3D models 30 may be laid out as a batch and sent to 3D printers located at one or more locations (i.e., the first and second locations 1, 11 and/or a third location 32). For example, in Singapore, there could be a single location for the 3D printer or multiple locations depending on the volume of customers and/or printable 3D models. The batch may be printed, packed and delivered to the customer or user. One or more of the printable 3D models 30 may be produced, printed, packed, further customized and/or delivered via at least one facility selected from a first facility 34, a second facility 36 and a third facility 38. The first facility 34 may include one or more facilities that may be associated with and/or located locally or adjacent with respect to the first location 1. The second facility 36 may include one or more facilities that may be associated with and/or located locally or adjacent with respect to the second location 11. The third facility 36 may include one or more facilities that may be associated with and/or located locally or adjacent with respect to the third location 32. This method or process shown in FIG. 1-3 may be completed and/or finished in, for example, under two hours, one hour or thirty minutes.

In embodiments, time of delivery may a factor in printable 3D models, such as, for example, vanity collectibles for customers or users, such as, for example tourists. Tourists typically may buy souvenirs as well as photos of themselves sitting in rides, places etc. These souvenir purchases may often be impulse purchases. Another factor with tourists may be the fact that tourists typically stay at a place for a few hours and then visit another place. This may create one or more challenges since printing of 3D models may traditionally take a multiple hours to merely print a vanity collectible, following which it needs to be cleaned, hardened, dried, packed etc. With the present systems, methods and processes, an order may be taken from the customer or user (i.e., tourist) to create their customized product and the product may be delivered when the customer or user (i.e., tourist) may be leaving the location that the souvenir purchase may have been made. For example, in a theme park, a tourist may enter say at 10 am in the morning and may spend, for example, the next six hours in the theme park. The order for their collectible and customized 3D model (i.e., printable 3D model 30) may be received at 11 am and the tourist may collect the 3D model before subsequently leaving the park. In embodiments, a turnaround time associated with the present systems, methods and processes may be, for example, as low as 60 minutes, 50 minutes or 40 minutes. In embodiments, the turnaround time associated with the present systems, methods and processes may be less than 60 minutes, 50 minutes or 40 minutes. In embodiments, the customer or user (i.e., tourist) may place an order for the printable 3D model 30 before entering, for example, a ride, and may collect the printed and customized 3D model when leaving the ride.

In one embodiment, a person or a group of people could relive their life as a timeline of aging. The 2D image of the person or the group of people may be, for example, a previous and/or older photograph of the person or group of people. For example, a couple who was married in, for example, 1968 and may have a photograph of themselves from 1968 which may, by using the present systems, methods and processes, create, generate and/or produce a printed and customized 3D model of themselves, in present day, of how their appearance forty-four years ago back in their youth. This may have great emotional and nostalgic values to customers or users, such as, for example, aging couples, families and/or the like.

In another embodiment, a customer or user may have an option of choosing the materials they want for their hair, dresses and/or the like. For example, a bride could get her wedding gown “replica” in the printed and customized 3D model which may be 3D printed or made in, for example, the actual real fabric of the wedding gown. Similarly, a customer or user may choose different hairstyles, head gear (turbans) which may also be with 3D printed or could be made of, for example, actual fabric or real hair. This may also apply to, for example, bodies of the customizable 3D printed vanity collectibles. For example, children may want to have printed bodies of favorite animation, cartoon and/or comic book characters or may want to a printed and customized 3D model of animation character or with the body of the character and the face of the child.

In yet another embodiment, not only may the printable 3D model of the persons in a photograph be created, but also the actual 3D background may be included in the printed and customized 3D model. For example, if a customer or user went to Egypt and took a photo with the pyramid in the background, the printed and customized 3D model may illustrate, include and/or show the customer or user standing in front of the pyramid. The printable 3D backgrounds may also include, for example, one or more printed animals or pets whose printable 3D models may be created, procured and/or obtained separately or together with the printed and customized 3D model of the customer or user.

In still another embodiment, a whole life of a person may be re-created via the printed 3D models, e.g. when the person was 2 years old, 5 years old and so on. The present systems, methods and processes may, for example, may produce, generate and create multiple printed and customized 3D models of one or more loved ones who may have passed away based on one or more photographs of the one or more loved ones. In still yet another embodiment, a single 2D image or 3D model may be utilized to print two or more customized 3D models of, for example, a person at different ages of life, such as, for example, one or more younger printed and customized 3D models and/or one or more older printed and customized 3D models.

The 2D image and/or the 3D model of the customer or user obtained may exhibit the first expression 20, which may be the actual facial expression of the user when the 2D image or the 3D scan was originally created, obtained and/or procured. In an embodiment, the printed and customized 3D model obtained from the present systems, methods and processes may have any different expression that the customer or user may desire, such as, for example, smiling, angry, disgust, painful, happy, surprised and/or the like. As a result, specialized individual or group printed 3D models may be created by utilizing the present systems, methods and processes. For example, a group of people may visit a theme park, and, while entering the theme park, the group of people may take or procure a digital photograph (i.e., 2D image) or a 3D face scan of each member of the group of people at the entrance of the theme park. At the entrance, the first expression 20 on the faces of each person of the group of people may be, for example, a natural or neutral expression. Subsequently, the group of people may go on or take a roller coaster ride and, during the roller coaster ride, expressions of the people in the group may change to fear, surprise, relief, smile and/or the like. In an embodiment, the group of people may request and receive printed and customized 3D models of the group of people sitting in the roller coaster ride with an expression of their choice which may or may be a different faces expression from the first expression 20 exhibited and originally obtained at the entrance. Through the present systems methods and/or processes, the person may not, for example, have to get one or more digital photographs taken, clicked and/or procured at each and/or every ride in the theme park to create, prepare and receive printable and customized 3D models of the person on each and/or every ride in the theme park.

In another embodiment, the group of people may be concerned to have a profile of theirs on, for example, an online website. One or more photos of the group of people and/or the one or more digital 3D models may already be present on the online website or web-accessible server and/or database, such as database 112 as shown in FIG. 4. In this embodiment, the group of people may or may not need to get and/or have a photo taken and/or procured at the theme park. The group of people may just chose a desired type of vanity collectible (i.e., during roller coaster ride, a boat ride and/or the like) and a printed and customized 3D model having that type of vanity collectible may be delivered to them.

In embodiments, the present systems, methods and/or processes may be implemented on system 100 as shown in FIG. 4. The system 100 may include, for example, at least one first computer 102 (hereinafter “the first computer 102”), at least one second computer 104 (hereinafter “the second computer 104”) and/or at least one computer server 106 (hereinafter “the computer server 106”) which may each be in electrical and/or digital communication with each other via at least one digital communication network 108 (hereinafter “network 108”). The first computer 102 may be located locally or remotely with respect to the second computer 104 and/or the server 106. In embodiments, the second computer 104 may be located locally or remotely with respect to the server 106. The second computer 104 may be electrically and/or digitally in communication with and/or connected to at least one printer 110 (hereinafter “the printer 110”), and the server 106 may be electrically and/or digitally in communication with and/or connected to at least one digital database 112 (hereinafter “the database 112”). The printer 110 may be located locally or remotely with respect to the second computer 104. The server 106 and/or the database 112 may be any computer server and digital database, respectively, as known to one of ordinary skill in the art.

In embodiments, the network 108 may be, for example, a personal area network (PAN), a local area network (LAN), a campus area network (CAN), a Metropolitan area network (MAN), a wide area network (WAN) and/or the like. The network 108 may operate according to basic reference model, such as, for example, a four-layer Internet Protocol Suite model, a seven-layer Open Systems Interconnection reference model and/or the like.

In an embodiment, the network 108 may be a wireless network, such as, for example, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. It should be understood that the network 108 may be any wireless network capable of connecting the first computer 102, the second computer 104 and/or the server 106 as known to one having ordinary skill in the art.

In an embodiment, the network 108 may be a fixed network, such as, for example, an optical fiber network, an Ethernet, a cabled network, a permanent network, a power line communication network and/or the like. In an embodiment, the network 108 may be a temporary network, such as, for example, a modern network, a null modem network and/or the like. In embodiments, the network 108 may be an intranet, extranet or the Internet which may also include the World Wide Web. The present disclosure should not be limited to a specific embodiment of the network 108.

In embodiments, the first computer 102 and/or the second computer 104 (hereinafter “the computers 102, 104) may be a desktop computer, a tower computer, a tablet personal computer (hereinafter “PC”), an ultra-mobile PC, a mobile-based pocket PC, an electronic book computer, a laptop computer, a media player, a portable media device, a PDA, an enterprise digital assistant and/or the like. In embodiments, the computers 102, 104 may be, for example, a 4G mobile device, a 3G mobile device, an ALL-IP electronic device, an information appliance or a personal communicator. The present disclosure should not be deemed as limited to a specific embodiment of the computers 102, 104.

The computers 102, 104 may have at least one display 114 (hereinafter “the display 114”), as shown for the first computer 102 in FIG. 4, for displaying or rendering information and/or multimedia, such as for example, the original article and/or the customized article in digital form. In embodiments, the display 114 may be, for example, an liquid crystal display (hereinafter “LCD”), a passive LCD, a light emitting diode (hereinafter “LED”), light emitting polymer or organic electro-luminescence, electronic paper (hereinafter “e-paper”), a surface-conduction electron-emitter display, a field emission display or an electrochromic display.

In embodiments, the display 114 may provide a touch-screen graphic user interface (hereinafter “touch-screen GUI”) or a digitized screen connected a microprocessor (not shown in the figures) of the computers 102, 104. The touch-screen GUI may be used in conjunction with a stylus (not shown in the drawings) to identify a specific position touched by a user 118 and may transfer the coordinates of the specific position to a microprocessor of the computers 102, 104 (not shown in the drawings). The microprocessor may obtain the information and/or multimedia data corresponding to the coordinates selected by the user 118 from the memory of the computers 102, 104. The computers 102, 104 may display or render the selected information and/or the multimedia data (i.e., the original article and/or the customized article in digital form) to the user 118. The original article and/or the customized article, in digital form, may be indicative of and/or associated with the user 118.

The first computer 102 may be connected to and/or in electrical and/or digital communication with at least one printer 116 and/or a printed indicia dispenser (not shown in the drawings) which may be located locally or remotely with respect to the computers 102, 104. The printer 116 and/or the printer 110 (hereinafter “the printers 116, 110”) and/or the printed indicia dispenser associated with the computers 102, 104 may be configured to generate, create and/or produce the original article and/or the customized article in physical form for distribution to the user 118 or a third party (not shown in the drawings). The printers 116, 110 and/or the printed indicia dispenser may be adapted and/or configured for printing the original and/or customized article which may be, for example, a physical book, a sticker book or album, a customized and transferrable frame or image or the printed and customized 3D model via one or more printing techniques as known to one of ordinary skill in the art. In an embodiment, the printer 110 of second computer 104 may create, generate and/or produce the original and/or customized article (i.e., physical comic book, sticker book or album, a transferrable frame or images and/or printed 3D model) which may subsequently shipped to the user via shipping company 120 or physically printed to a location local or adjacent to the user 118 and/or the third party.

In embodiments, one or more 2D images of the customer or user may be obtained by, procured by and/or uploaded to, for example, the first computer 102. The one or more 3D generating technologies may be executed by, implemented by and/or utilized by, for example, at one of the computers 102, 104 to convert the one or more 2D images to one or more 3D models and/or 3D images which may be stored in at least one of the memories of the computers 102, 104 and/or the database 112. In an embodiment, at least one of the instructions, one or more computer programs and/or software, which may be stored in and accessed from at least one of the memories of the computers 102, 104 and/or the database 112, may be executed by at least one of the computer 102, 104 to convert the one or more 2D images to the one or more 3D models and/or images. The one or more converted 3D models and/or 3D images may be utilized by at least one of the computer 102, 104 to create, generate and/or produce one or more customized articles. To create, generate and/or produce the one or more customized articles, the one or more 3D models and/or 3D images may be added to, included into and/or incorporated into one or more original articles to achieve the one or more customized articles via at least one of the computers 102, 104. In an embodiment, at least one of the instructions, one or more computer programs and/or software may be executed and/or performed by at least one of the computers 102, 104 to add, include and/or incorporate the one or more converted 3D models and/or images into the one or more original articles to achieve, create, produce and/or generate the one or more customized articles. In embodiments, the one or more converted 3D models and/or images may be utilized by at least one of the computers 102, 104 to modify the one or more original articles to achieve, create, produce and/or generate the one or more customized articles.

In embodiments, the one or more converted 3D models and/or images may be utilized by at least one of the computers 102, 104 to customize one or more frames associated with the one or more original articles. The one or more customized frames may be added to, included in and/or incorporated into the one or more original articles to achieve, create, generate and/or produce the one or more customized items. The one or more customized items, which may have the one or more customized frames incorporated or included therein, may be digitally distributed via, for example, at least the display 114 of the first computer 102 and/or may be physically distributed via, for example, at least the printer 116 associated with the first computer 102 and/or the printer 110 associated with the second computer 104.

In embodiments, at least one of the instructions, one or more computer programs and/or software may be executed and/or performed by at least one of the computers 102, 104 to modify the one or more frames with the one or more converted 3D models and/or images to achieve, create, generate and/or produce the one or more customized frames. The one or more customized frames may be physically distributed via, for example, at least the printer 116 associated with the first computer 102 and/or the printer 110 associated with the second computer 104. The distributed one or more customized frames may be, for example, one or more transferrable frames and/or images (hereinafter “transferrable images”) which may utilized to modify the one or more original articles, in physical form, to achieve, create, generate and/or produce one or more customized items, in physical form. In an embodiment, the transferrable images, in physical form, may be added to, adhered to, connected to and/or attached to the one or more original articles, in physical form, to achieve, create, generate and/or produce the one or more customized items, in physical form. In an embodiment, the distributed one or more customized frames and/or transferrable images may be the one or more customized items, in physical form, which may be utilized to modify the one or more original articles, in physical form, by, for example, adding, adhering, connecting and/or attaching them to the original articles, in physical form.

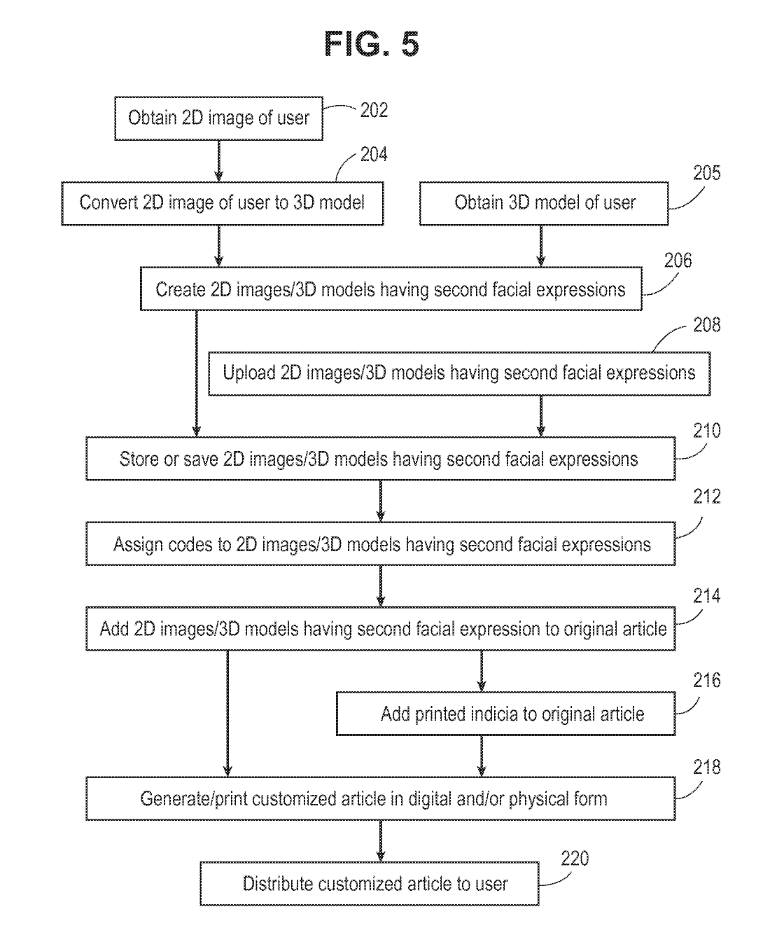

FIG. 5 illustrates a method or process 200 (hereinafter “method 200”) for generating, producing and distributing the one or more customized articles, in digital and/or physical form, in an embodiment. At step 202, the at least one 2D image of the user 118 having the first expression 20 may be obtained, provided, accessed and/or procured by the user 118 via the first computer 102 or from the database 112 via the first computer 102 and/or the server 106 over the network 108. The computers 102, 104 may utilize, execute and/or perform at least one of the instructions, computer programs and/or software, stored therein and/or stored in the database 112 accessible via the server 106 and/or the network 108, to convert the at least one 2D image of the user 118 having the first expression 20 to the at least one 3D model and/or image of the user 118 having the first expression 20 as shown at step 204. At step 205, at least one 3D model and/or image of the user 118 having the first expression 20 may be directly or indirectly obtained from the first computer 102 or from the database 112 via the first computer and/or the server 106 over the network 108.

After the at least one 3D model and/or image of the user 118 having the first expression 20 may be created, generated and/or obtained by the computers 102, 104, the computers 102, 104 may utilized, execute and/or perform at least one of the instructions, one or more computer programs and/or software to create a plurality of 2D images and/or 3D models and/or images of the user having a plurality of second facial expressions as shown at step 206. In an embodiment, a plurality of 2D images (i.e., hand sketches or drawings as shown in FIG. 7) of the user having a plurality of second facial expressions may be scanned and/or uploaded to the computers 102, 104 by the user as shown at step 208. The plurality of 2D images that may have been scanned and/or uploaded by the user may be converted in 3D models by software which may be stored in the server 112 and/or the computers 102, 104.

At step 210, the plurality of 2D images and/or 3D models and/or images of the user exhibiting the plurality of second facial expressions may be stored in at least one of the memories of the computers 102, 104 and/or the database 112 accessible by the server 106 over the network 108. At least one of the instructions, one or more computer programs and/or software, which may be stored in the database 112 and/or the memories of the computers 102, 104, may be utilized, executed and/or performed to assign one or more unique user codes to the plurality of 2D images and/or 3D models and/or images of the user having the plurality of second facial expressions as shown at step 212. At least one of the instructions, one or more computer programs and/or software may be utilized, executed and/or performed to add, include and/or incorporate the one or more 2D images and/or 3D models and/or images selected from the plurality of 2D images and/or 3D models and/or images into the original article, such as, for example, a digital story book and/or a physical story book to create, generate and/or produce the customized article as shown at step 214. As a result, the customized article may be customized to include one or more 2D images and/or 3D models and/or images of the user having one or more second facial expressions selected from the plurality of second facial expressions of the user.

In embodiment, at least one of the instructions, one or more computer programs and/or software may be utilized, executed, performed by at least one of the computers 102, 104 to determine and/or select the 2D images and/or 3D models and/or image of the user to be added, included and/or incorporated into the original article based on one or more of the unique user codes assigned to the 2D images and/or 3D models and/or images of the user and/or based on one or more of the unique article codes assigned to the original article and/or to at least one portion of the original article, such as, for example, a page of the physical story book or one or more customized frames of the digital story book. At least one of the instructions, one or more computer programs and/or software may be utilized, executed and/or performed by at least one of the computers 102, 104 to match or correlate the unique user codes of the 2D images and/or 3D models and/or images to the unique article codes of the original article and/or the at least one portion of the original article to create, generate and/or produce the customized article and/or the one or more customized frames.

At least one of the instructions, one or more computer programs and/or software may be utilized, executed and/or performed by at least one of the computers 102, 104 to add and/or insert one or more printed indicia, such as, for example, text representing the name of the user into the original article in digital and/or physical form as shown in step 216. For example, physical text including the name of the user may be added to the physical story book or may be displayed on one or more customized frames of the digital story book. In an embodiment, one or more audio signals indicative of the one or more printed indicia, such as, for example, a name of the user may be generated and/or produced at one or more customized frames of the customized article, such as, for example, a digital story book, a video game and/or an animated comic book via, for example, at least one of the computer 102, 104.

At step 218, at least one of the computers 102, 104 and/or the server 106 may utilize, execute and/or perform at least one of the instructions, one or more computer programs and/or software that generates, produces and/or creates the finalized customized article, in digit and/or physical form, for distribution to the user. The printers 116, 110 may print the one or more customized articles for distribution to the user when the one or more customized articles may be in physical form. At step 220, the finalized customized article, in digital and/or physical form, may be distributed to the user for use either directly or via the shipping company 120 as shown in FIG. 4. In digital form, the one or more customized articles may be, for example, accessible via the computers 102, 104, may be stored within at least one of the memories of the computers 102, 104, may be stored in the database 106 which may be accessible via the server 106 over the network 108, and/or may be displayable by the display 114 of the first computer 102.

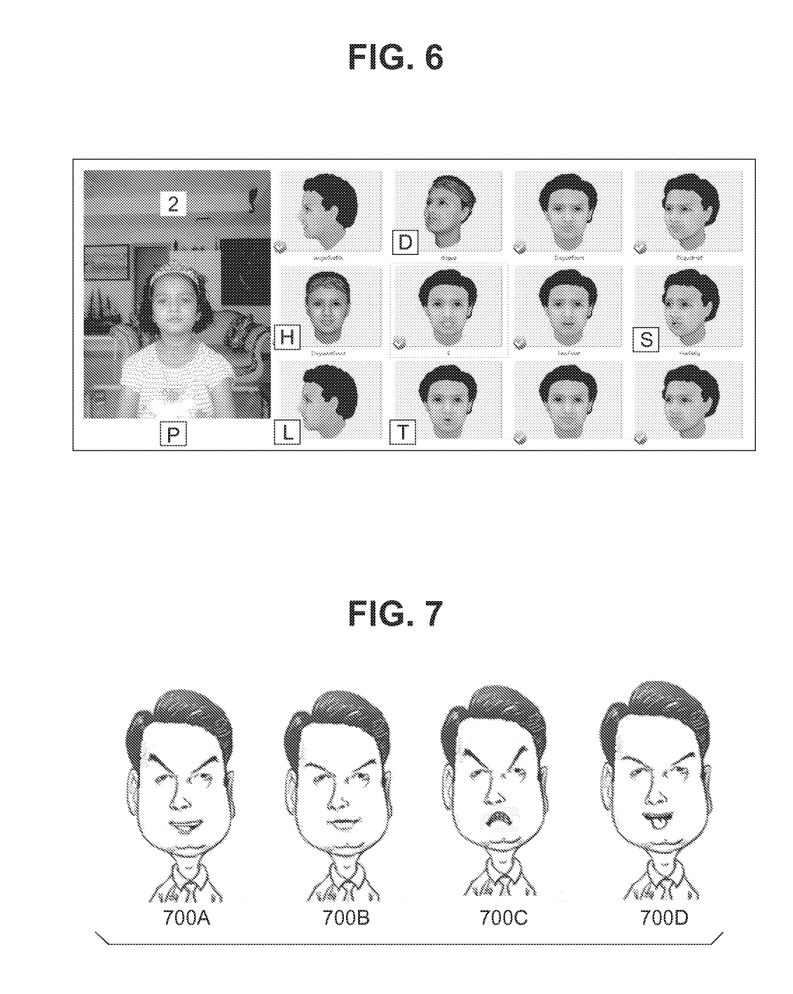

Generation and/or creation of the plurality of 2D images and/or 3D models and/or images of the user having the plurality of second facial expressions as shown in step 206 of the FIG. 5 may be achieved by utilizing a single 2D image, such as, for example, a digital photograph of the user as illustrated in FIG. 6. In FIG. 6, a 2D digital photograph P (hereinafter “the 2D photo P”) of the user may be obtained, accessed and/or procured. For example, the 2D photo P may be sent from a mobile device and/or accessed and/or uploded from the online website which may be accessible via the server 106 over the network 108. The 2D photo P may have a 2D background 2 which may be behind and/or adjacent to the person shown in the 2D photo P. In an embodiment, the 2D photo P may be used to covert the face of the user into one or more 3D models and/or images of the head of the user. The one or more 3D models and/or images of the head of the user may be animated to create the plurality of second facial expressions of the user, via utilization, execution and/or perform of at least one of the instructions, one or more computer programs and/or software by at least one of the computers 102, 104. The resulting 3D models of the user having the second facial expressions may be saved or stored, in at least one of the memories of the computers 102, 104 and/or the database 112, as a plurality of 2D images. Some examples of the various second facial expressions of the user may be shown in FIG. 6 and are described below as:

H—the hairstyles are changed;

D—the user is looking in a different direction;

L—the user's profile look;

T—user talking; and

S—user's side look.

In step 206, the same 2D photo P of the user is utilized to create, for example, a face looking in any direction, several expressions, change of hairstyles and accessories like earnings, eyewear, bands. As a result, a plurality of 2D images may be generated from the same 2D photo P, such as, for example, hundereds of 2D images having different second facial expressions may be generated and/or created from the 2D photo P. The plurality of generated 2D images, which may be stored in at least one of the memories of the computers 102, 104 and/or the database 112, may be utilized by at least one of the computers 102, 104 to modify the one or more original articles to achieve, create, produce and/or generate the one or more customized items. The plurality of generated 2D images may be added, incorporated and/or included into the one or more original articles to achieve, create, produce and/or generate the one or more customized items. One or more of the plurality of generated 2D images may be utilized to modify the one or more frames associated with the one or more original articles to achieve, create, produce and/or generate the one or more customized frames. One or more of the plurality of generated 2D images may be utilized to achieve, create, produce and/or generate the one or more transferrable images which may be added to, adhered to, connected to, attached to, include in and/or incorporated within the one or more original to achieve, create, produce and/or generate the one or more customized items.

In another embodiment, the plurality of 2D images of the user having different second facial expressions of the user may be created directly into 2D images without utilizing the 3D model of the user. The different second expressions of the user may be created by, for example, utilizing, executing and/or preforming at least one of the instructions, one or more computer programs and/or software (described in FIG. 5) or may be hand sketched (as shown in FIG. 7). FIG. 7 shows a cartoon character of a user having a plurality of different facial expressions 700A, 700B, 700C and 700D. So for each user, the array of facial expressions may be be created once the 2D photo P of the user (or 3D model of the user) may be obtained. As discussed above, the one or more 3D models and/or images of the user may be obtained directly through a laser scanner or kinect or camera at the location local with respect to the user or uploaded from one or more prexisting 3D models from an online website accessible via the server 106 over the network 108.

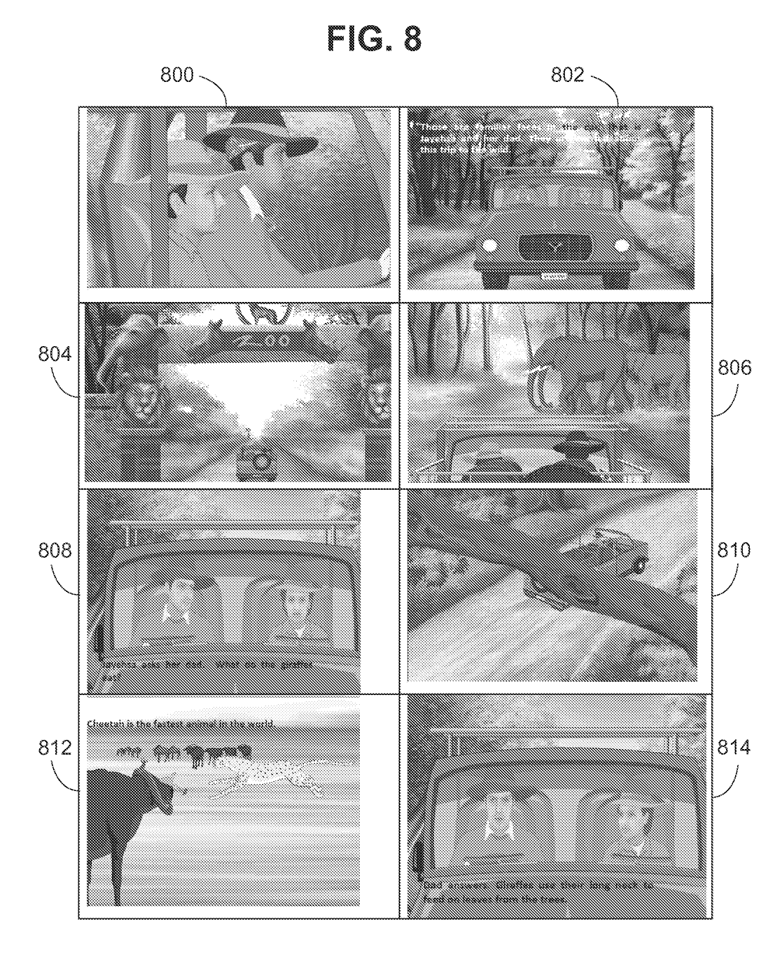

Creation and generation of at least one customized article, which includes one or more 2D images of the user as described in step 218 of FIG. 5, may be illustrated by the images set forth in FIG. 8. For example, the customized article may be digital story book which includes a father and his daughter as they are going on and/or experiencing a safari trip. As shown in FIG. 8, one or more images of the father and daughter may be added to original article, such as, for example, digital story book and printed indicia, such as, for example, text display including the name of the daughter may be added to original article to achieve, produce, generate and/or create the customized article. The one or more 2D images of the user may be modify the one or more frames associated with, for example, the digital story book, to achieve, create, generate and/or produce the one or more customized frames 800, 802, 808 and 814 of the original digital story book. The one or more customized frames may be added to, incorporated into and/or included into the original frames 804, 806, 810 and 812 the original digital story book to achieve, create, produce and/or generate a customized digital story book which may include the father and daughter.

The first expression 20 of the user originally shown in the original 2D photo P may usually be a natural or neutral facial expression (see FIGS. 2 and 6). However, the user may want to be featured in, for example, a digital story book that is an exciting adventurous digital story. During the digital story, different facial expressions of a character in the original adventurous story may include fear, surprise, relief, smile and/or the like. In an embodiment, a full customized digital story book of the adventurous story including animation may be created and/or generated wherein the user may be a character of the digital story book and one or more of the second facial expressions of the user may be selected from the plurality of second facial expressions. At least one of the instructions, one or more computer programs and/or software may be utilized, executed and/or performed by at least one of the computer 102, 104 to (i) match to the original facial expression of the original character in the original article at one or more specific frames or pages of the original article with a 2D image or a 3D model and/or image having a corresponding second facial expression of the user, (ii) select the correct or corresponding second facial expression of the user, from the plurality of 2D images or 3D models or images having the plurality second facial expressions, that matches or substantially matches the original facial expression of the original character in the original article; and/or (iii) insert at least one 2D image or 3D model or image of the user having the matched and/or selected second facial expression of the user into at least one frame or page of the original article to achieve, produce, generated and/or create a customized article, such as, for example, a story book in digital and/or physical.

By generating, creating and utilizing the plurality of 2D images of the user having the plurality of second facial expressions, the user may not be required to create a 2D photo having each and every facial expression and/or looking in each and every direction. In another embodiment, the user may have a profile account accessible from the online website. The 2D images and/or 3D models and/or images of the user may be accessible via the online website. In embodiment, when the 2D images and/or 3D models or images of the user are accessible via the online website, the user may chose or select the one or more desired types of customized articles, such as, for example, story books, sticker books or albums, games, animations, in digital and/or physical form, via, for example, the first computer 102 which may by subsequently produced, customized and distributed to the user via the present systems, methods and/or processes.

In embodiments, the original character of the original article may be exhibiting speaking or talking actions in one or more frames or pages of the original article. In order to customize those one or more frames, second facial expressions of the user may be utilized to create, provide, generate and/or produce lip sync actions corresponding to the speaking or talking actions executable by the original character in the original article. At least one of the instructions, one or more computer programs and/or software may be utilized, executed and/or performed by at least one of the computers 102, 104 to create and/or generate an array of 2D images and/or 3D models and/or images of the user which may (i) match and/or correspond to the speaking or talking actions of the original character in the one or more frames or pages, (ii) be utilized to accurately or substantially accurately provide lip syncing actions that correspond to or substantially correspond to the speaking or talking actions of the original character at the one or more frames or pages, and/or (iii) inserted the one or more corresponding and customized frames into the original frames or pages of the original article to generate and/or create the customized article.

For customizing articles that are in the digital form, such as, for example, a 2D animation, a video game or a digital story book, one or more individual frames or images may be customized by addition one or more 2D images and/or 3D models or images of the user into the one or more individual and original frames or images of the original article. For example, a digital story book may have twenty images, while a 2D animation or a video game film may play between twenty and hundred images in a single second. For customizing articles in the 2D form, each frame or page may be customized by at least one of the instructions, one or more computer programs and/or software which may be executable by at least one the computers 102, 104. For example, at least one of the instructions, computer programs and/or software may be utilized, executed and/or performed to (i) insert one or more 2D images of the user into one or more frames or pages in place of an original character of the original article, (ii) replace the original character in one or more frames or pages of the original article with one or more matching and/or corresponding 2D images of the user, (iii) create the one or more customized frames or pages of the original article whereby the original character is replaced by one or more 2D images of the user. The one or more customised frames may be joined together to achieve, create, produce and/or provide a customized story book, including one or more 2D images of the user, which may be distributed and/or accessed in digital form or physical form.

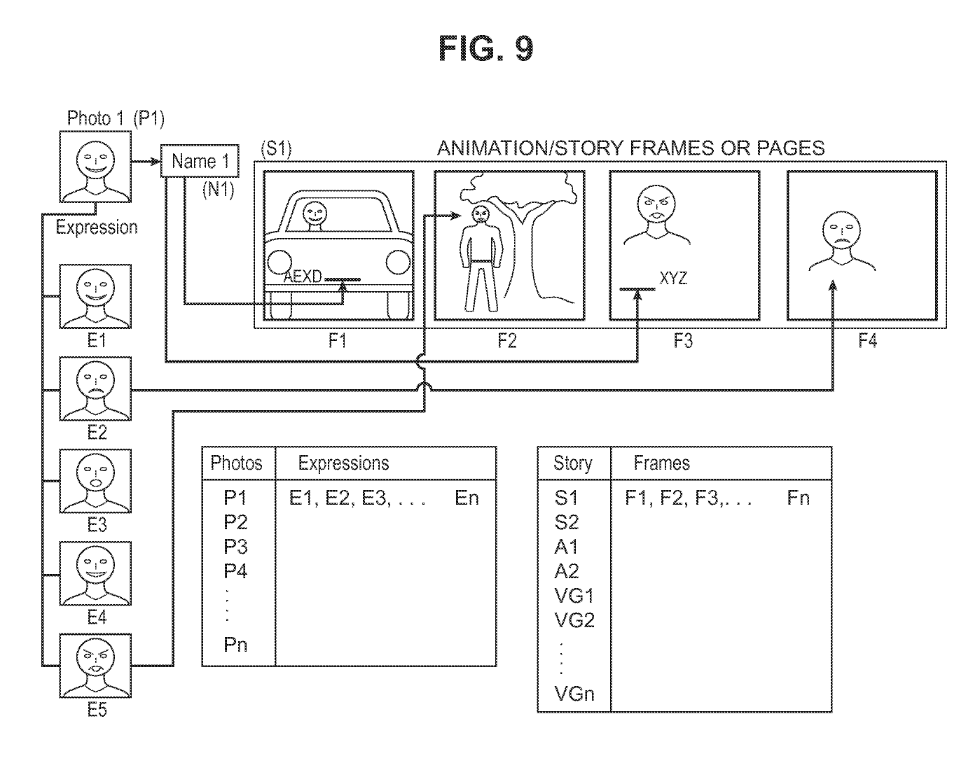

In an embodiment, 2D photo P1 (shown in FIG. 9) may be a photo of the user which may be uploaded to at least one of the computers 102, 104 and/or the server 106 and/or stored in at least one of the memories of the computers 102, 104 and/or the database 112. The 2D photo P1 may be utilized to create the plurality of 2D images of the user which show the user having the plurality of second facial expressions, for example second facial expressions E1, E2, E3, E4, E5 to En via at least one of the instructions, computer programs and/or software which may be executed by at least one of the computers 102, 104. As a result, the 2D photos P1, P2, P3, P4 to Pn, which may each include a facial expression of the user, may be assigned unique expression codes, such as, E1, E2, E3, E4, E5 to EN as shown in FIG. 9. The 2D photos P1, P2, P3, P4 to Pn may be created, generated, produced and/or achieved by at least one of the computers 102, 104 utilizing, executing and/or performing at least one of the instructions, the one or more computer programs and/or software. Each second expression of the user may be assigned a unique user code, such as, for example, a surprised facial expression where the head of the user is facing forward may be second facial expression E2 of the user. As a result, for one or more created 2D photos P1, P2, P3, P4, P5 to Pn, second facial expression E2 may be the same second facial expression of the user, such as, for example, a surprised expression with the face of the user facing forward.

In an embodiment, each original article may be assigned and/or may have a preset unique article code, such as, for example, S1, S2, to Sn, A1, A2 to-An and/or VG1, VG2 to VGn. An original article may be assigned S1 which may be divided and/or broken down into more than one frames or pages, such as, frames F1, F2 . . . Fn. In at least one frame or page, a character's presence may be determined by the pixels where the character may be present in every frame and the corresponding and/or matching 2D image of the user may be added and/or inserted into the at least one frame or page. Similarly, text which may include the name of the user may appear in one or more frames or pages. For example, when animation may be created, each frame or page may require a specific facial expression of the user to be selected and inserted into each frame or page in order to customize the animation. In an embodiment shown in FIG. 9, the 2D image of the user having facial expression E1 may inserted into frame F1, the 2D image of the user having facial expression E5 may be inserted into frames F2 and F3, text including the name of the user may be inserted into frame F3, and the 2D image of the user having facial expression E2 may be inserted into frame F4. This process may be repeated for up to every frame or page of the digital animation and/or for up to every character being inserted when multiple users may be present (i.e. the father and daughter shown in FIG. 8). After all the necessary frames have been customized with the one or more user(s), the one or more customized frames may joined, inserted and/or incorporated into the original frames or pages and/or may be digitally stitched together by execution of at least one of the instructions, one or more computer programs and/or software via at least one of the computers 102, 104.

In an embodiment, from each original 2D photo of the user, twenty to hundred second facial expressions may be created, generated and/or produced which may include multiple directions of the head of the user, multiple directions of the eyes of the user, multiple expressions of the face of the user.

In an embodiment, it may be, for example, assumed:

1) about twenty expressions per face;

2) about twenty-five images in about story and about five stories;

3) about ten animations of about five minutes each; and

4) at about twenty-five frames per second of animation—each five minute animation may have about 7500 frames to be customised.

At just about 1000 users, wanting to chose from any of the about 10 animation film or stories, up to millions of customizations may need to be carried out in the frames.

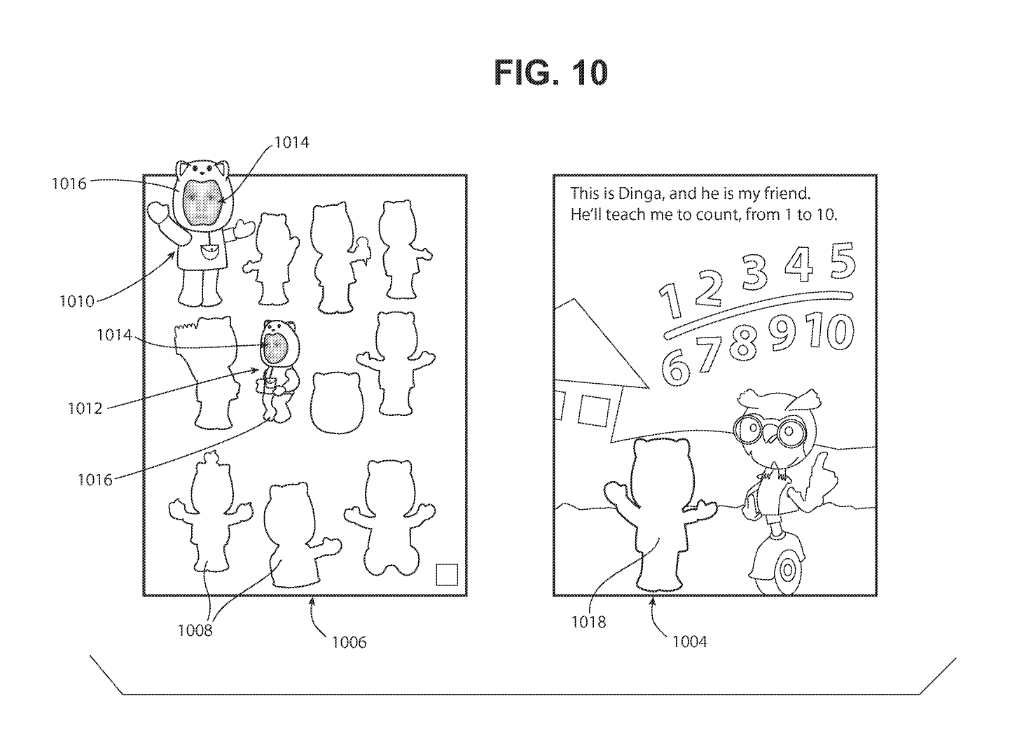

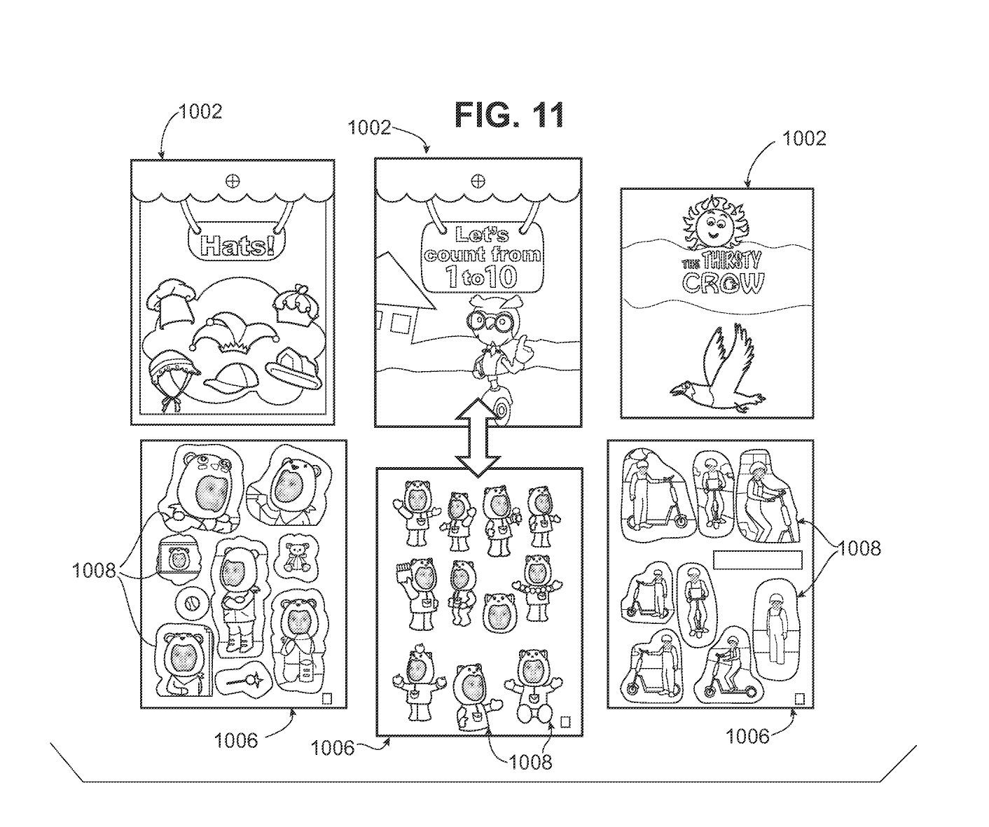

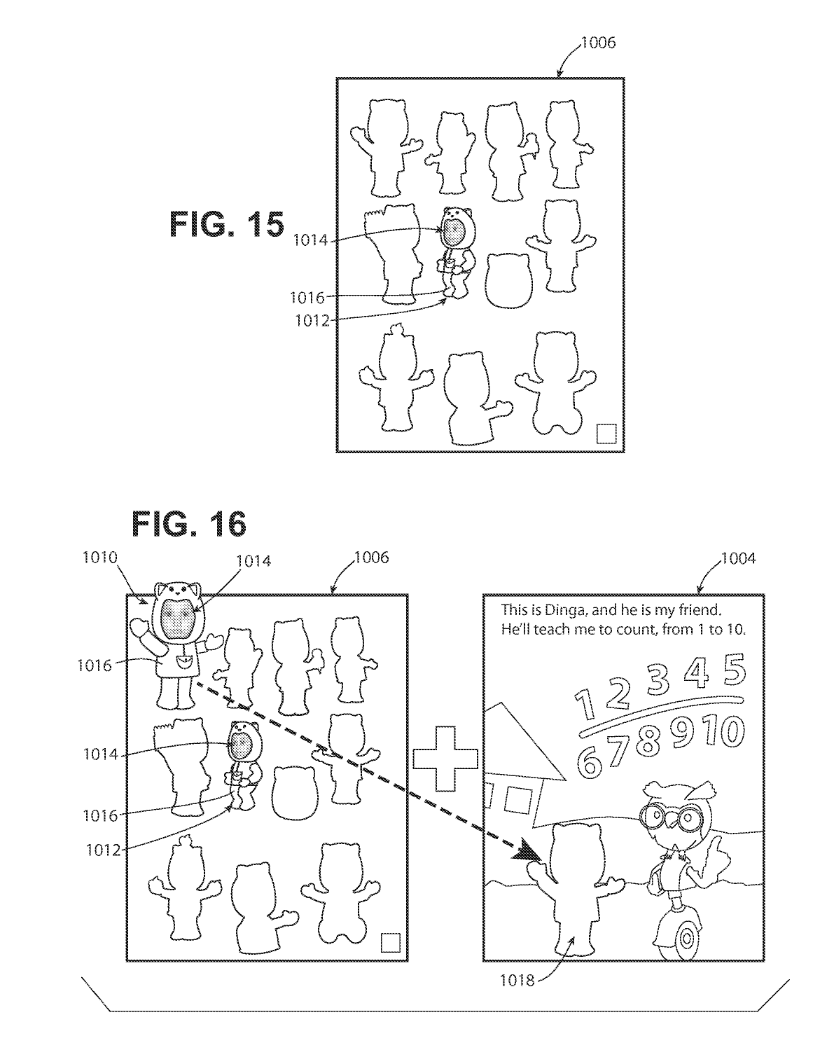

FIGS. 10-16 show one or more original articles which may be, for example, a plurality of sticker books or albums 1002 (hereinafter “the sticker books 1002”) in an embodiment as shown in FIG. 11. The sticker books 1002 may have one or more original pages 1004 having one or more original printed indicia thereon, as shown in FIGS. 10 and 16, and/or one or more customizable pages 1006, as shown in FIGS. 10, 11 and 13-16, which may each have a plurality of transferrable images 1008, as shown in FIGS. 10, 11, 13 and 14. The one or more original printed indicia on the one or more original pages 1004 may illustrate, provide and/or display one or more stories and/or illustrations. The one or more stories and/or illustrations which may be illustrated, provided and/or displayed via the one one or more original printed indicia on the original pages 1004 of the one or more sticker books 1002 may be any type of story and/or illustration as known to one of ordinary skill in the art. The present disclosure should not be deemed limited to a specific number of original pages 1002, a specific number of customizable pages 1006 and/or a specific number of transferrable images 1008 which may be included and/or incorporated within the sticker books.

The transferrable images 1008 of the one or more customizable pages 1006 may be one or more adhesive items, such as, for example, one or more adhesive stickers or adhesive decals. The adhesive stickers may be, for example, adhesive labels, adhesive posters, adhesive patches, adhesive tapes or any combination thereof. The transferrable images 1006 may be made of, for example, at least one paper, at least one plastic, one or more polymers, one or more glossy layers, one or more ink or pigment layers, at least one release layer or any combination thereof. The transferrable images 1008 and/or the one or more customizable pages 1006 may have a first side having at least one adhesive thereof and a second side, located opposite to the first side, having one or more customized and/or non-customized printed indicia thereon. The at least one adhesive on the first side of the transferrable images 1008 may be an adhesive composition, for example, a pressure-sensitive adhesive composition, a heat-curable adhesive composition, a crosslinkable adhesive composition and/or the like. The printed indicia on the second side of the transferrable images 1008 may be 2-dimensional printed indicia and/or 3-dimensional printed indicia which may include, for example, images, designs, pictures, figures, characters, graphics, photographs, symbols or any combination thereof. The transferrable images 1008 may or may not have different and/or multiple appearances, sizes, shapes, dimensions, magnifications, view angles and/or colours which may be dependent upon or independent from specific sticker books, specific original pages of the sticker books and/or specific blank or non-printed areas of the original pages of the sticker books.

For example, each of the one or more customizable pages 1006 of the sticker books 1002 may have at least more than one transferrable image 1008, such as, for example, at least a first transferrable image 1010 and a second transferrable image 1012 as shown in FIGS. 10, 15 and 16. Each of the one or more transferrable images 1006, the first transferrable image 1010 and/or the second transferrable image 1012 may have customized printed indicia 1014 and non-customized printed indicia 1016 as shown in FIGS. 10, 15 and 16. The non-customized printed indicia 1016 may be dependent upon and/or indicative of the sticker book 1002 and/or the story which may be illustrated and/or displayed in the each of the sticker books 1002. For example, the non-customized printed indicia 1016 of the one or more transferrable images 1006 may be an illustration, such as, for example, a cartoon illustration, cartoon character, a drawing, a sketch, an image, a photograph, a design, a graphic, a caricature, a story character, a combination thereof and/or the like.

The customized printed indicia 1014 for the one or more transferrable images may be or may include at least one selected 2D image of user from the plurality of 2D images of the user having at least one selected facial expression from the plurality of second facial expressions of the user. The at least one selected 2D image of the user and/or the at least one selected facial expression of the user may match, may be indicative of and/or may correspond to at least one 2D image of a character which may be illustrated within the sticker book and/or to at least one facial expression of the character which may be illustrated within the sticker book. At least one of the instructions, one or more computer programs and/or software may be utilized, executed and/or performed by at least one of the computers 102, 104 to determine and/or select the matching, indicative and/or corresponding at least one 2D image of the user and/or the at least one facial expression of the user to be included in the customized printed indicia 1014 of the one more customized printed indicia 1014 of the one or more transferrable images 1008, the first transferrable image 1010, the second transferrable image 1012 or any combination thereof.

The original pages 1004 of the sticker books 1002 may have and/or may illustrate at least one blank or non-printed area 1018 (hereinafter “the blank area 1018”) as shown in FIGS. 10 and 16. The blank area 1018 may have dimensions and/or a perimeter which may be sized and/or configured to be covered and/or receive the one or more transferrable images 1006, the first transferrable image 1010 or the second transferrable image 1012. At least one of the one or more transferrable images 1008, the first transferrable image 1010 or the second transferrable image 1012 may have dimensions and/or a perimeter which may be the same as or substantially similar to the dimensions and/or the perimeter of the blank area 1018. As a result, the one or more transferrable images 1006, the first transferrable image 1010 or the second transferrable image 1012 may sized and/or configured to cover or substantially cover the blank area 1018 when applied or adhered to the blank area 1018 on the original page 1004. Thus, the original page 1004 may be modified by addition and/or adhesion of the one or more transferrable images 1008, the first transferrable image 1010 or the second transferrable image 1012 to the blank area 1018 to achieve, create and/or produce the customized item, such as, for example, the customized sticker book 1002. As a result, the customized sticker book 1002 may illustrate, show and/or display a story wherein one or more characters of the story may be customized, via the one or more transferrable images 1006, to be one or more customers and/or users of the present systems, methods and/or processes.

FIG. 10 shows an original page 1004 and a customized page 1006 of a sticker book 1002 in an embodiment. The original page 1004 may have the blank area 1018 and the customized page 1006 may have one on more transferrable images 1008, the first transferrable image 1010 and/or the second transferrable image 1012. At least one of the one on more transferrable images 1008, the first transferrable image 1010 and/or the second transferrable image 1012 may have at least one of the customized printed indicia 1014 which may include at least one of the 2D images of the user have at least one second facial expression of the user. In an embodiment, the first transferrable image 1010 may have dimensions and/or a perimeter that may be same as or substantially similar to dimensions and/or a perimeter of the blank area 1018 on the original page 1004. In embodiments, at least the one or more transferrable images 1006, the first transferrable image 1010 and/or the second transferrable image 1012 may be sized and/or configured to cover or substantially cover the blank area 1018 when adhered, added, connected and/or attached to the original page 1004. As a result, the original page 1004 may be modified and/or customized to include the at least one 2D image of the user having at least one second facial expression via at least one of the one or more transferrable images 1008, the first transferrable image 1010 and/or the second transferrable image 1012.

FIG. 11 shows different sticker books 1002 which may have different corresponding customized pages 1006 which each may include one or more different one or more transferrable images 1008. Each set of different one or more transferrable images 1008 may correspond with and/or may be indicative of each different sticker books 1002. Each set of different transferrable images 1008 may be indicative of, dependent upon or independent from the story being illustrated, shown and/or displayed through the different sticker books 1002.

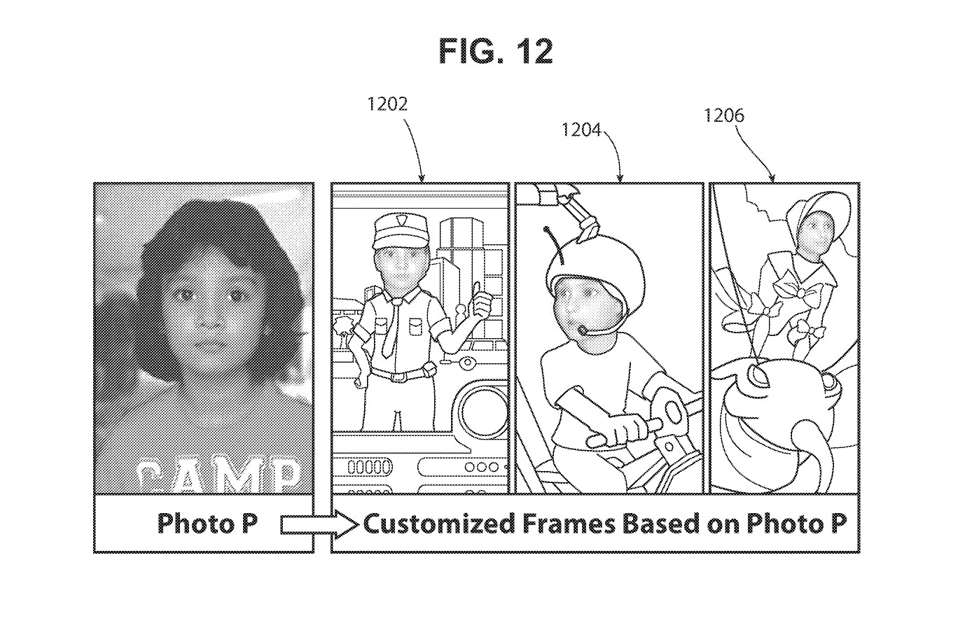

FIG. 12 illustrates methods and/or processes 1200 for utilizing a 2D photograph of a user to modify one or more original frames to create, produce and/or generate one or more customized frames for modifying the one or more original articles. The one or more customized frames may be based on the 2D photo P of the user which may be utilized to create, for example, one or more faces looking in one or more directions, having one or more expressions, along with one or more accessories (i.e., different styles of headgear) and/or one or more backgrounds and/or foregrounds. For example, the 2D photo P of the user may be utilized to create three different faces looking in three different directions having three different facial expresses which may be utilized to modify three different original frames 1202, 1204, 1206 of an original article. As shown in FIG. 12 the three different original frames 1202, 1204, 1206 having three different accessories, headgears, backgrounds and/or foregounds may be modified with the three different facial expresses of the user to achieve, create, generate and/or produce three customized frames which may be incorporated into the original article to create, produce and/or generate a customized item, in digital and/or physical form. In an embodiment, the three different faces of the user may be illustrated or provided on the three individual and/or separate transferrable images 1008 which may be added, adhered, connected and/or attached to the original article, such as, for example, one of the original pages 1004 of one of the sticker books 1002 to create, generate and/or produce the customized item.

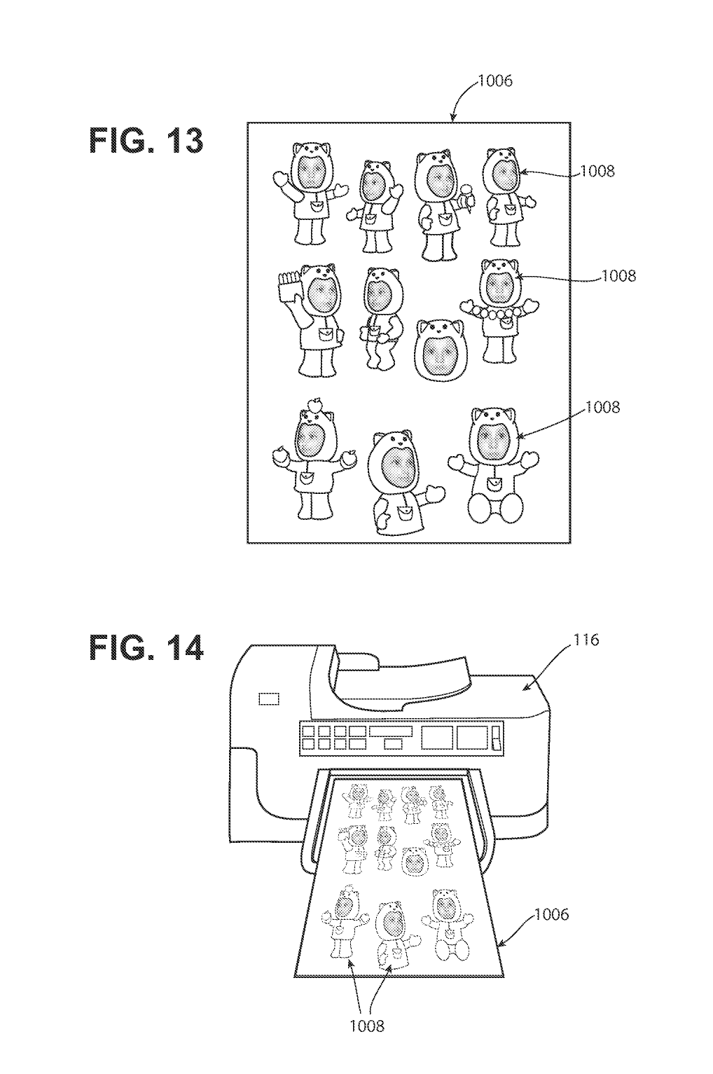

FIG. 13 illustrates a customizable page 1006 having one or more transferrable images 1008 of the user which may be customized based on the 2D photo P of the user. The customizable page 1006 may have or include, for example, more than 5, more than 10 or more than 15 transferrable images 1008 as shown in FIG. 13. Each of the transferrable images 1008 provided on the customizable page 1006 may have one or more different facial view of the user, one or more different facial expressions of the user, one or more accessories associated with the user and/or one or more body poses of a character body associated with the one or more faces of the user. For example, the character body may be a cartoon character body and each transferrable image may illustrate the cartoon character body in a different body pose having one or more different faces of the user.

FIG. 14 illustrates at least one method or process for creating, producing and generating the customizable page 1006 having one or more transferrable images 1008 as shown in FIG. 13. In an embodiment, at least one of the computers 102, 104 and/or the server 106 may transmit printing instructions to the printer 116 which may or may not be located locally with respect to the user. The printing instructions received by the printer 116 may instruct the printer to print different 2D images of the user having different facial view and/or facial expressions onto the transferrable images 1008 of the customizable page 1006. As a result, the transferrable images 1008 of the customizable page 1006 may be modified by the different 2D images of the user to achieve, create, produce and generate customized transferrable images 1008 of the user. After printing is completed by the printer 116, the customized transferrable images 1008 may be distributed to the user and/or a third party either directly if the printer 116 is located locally with respect to the user and/or the third party or indirectly via, for example, the shipping company 120 if the printer 116 is located remotely with respect to the user and/or the third party. The customized transferrable images 1008 may be subsequent utilized by the user and/or the third party to modify the original article to create, generate and/or produce the customized article which includes and/or incorporates the customized transferrable images 1008 therein.

FIG. 16 illustrates at least one method and/or process for customizing an original article with one or more customized transferrable images 1008 to create, generate and/or produce a customized article. The one or more customized transferrable images 1008 may be added, adhered, connected and/or attached to one or more blank areas 1018 of one or more original pages 1004 of the original article to create, generate and/or produce the customized article. For example, at least one of the first customized transferrable image 1010 or the second customized transferrable image 1012 may be added and/or adhered to the blank area 1018 of the original page 1004 as shown in FIG. 16. When the dimensions and/or perimeter of the blank area 1018 and one of the first or second customized transferrable images 1010, 1012 match or substantially match, the matching customized transferrable image may be added and/or adhered to the blank area 1018 of the original page 1004. As shown in FIG. 16, the first customized transferrable image 1010 has matching or substantially matching dimensions and/or perimeter with the blank area 1018 of the original page 1004. The user and/or the third party may remove, separate, cut and/or peel the first customized transferrable image 1010 from the customizable page 1006 and apply, adhere, attach and/or connect the first customized transferrable image 1010 to the blank area 1018 via the adhesive layer on the first side of the first customized transferrable image 1010. As a result, the original page 1004 may be customized with the first customized transferrable image 1010 to create, generate and/or produce the customized article.

In summary, the present systems, methods and/or processes may provide mass and efficient production, distribution and/or customization of one or more vanity and/or customizable articles in digital form and/or in physical form.

We claim:

1. A method for customizing at least one original article and distributing at least one customized article, the method comprising at least:
obtaining, via a first computer, at least one 2-dimensional image of at least one user;
converting the at least one 2-dimensional image to at least one 3-dimensional model of the at least one user;
modifying the at least one original article with the at least one 3-dimensional model of the at least one user to produce the at least one customized article, wherein the at least one customized article incorporates the at least one converted 3-dimensional model therein; and
printing and distributing the at least one customized article via at least one 3-dimensional printer.

2. The method according to claim 1, wherein at least one 2-dimensional image of the at least one user comprises at least one first facial expression of the at least one user, and further wherein the at least one 3-dimensional model of the at least one user comprises at least one second facial expression of the at least one user, wherein the at least one second facial expression is a different facial expression than the at least one first facial expression of the at least one user.

3. The method according to claim 1, wherein the customized article is a 3-dimensional printed article, sculpture or model.

4. The method according to claim 1, wherein the obtaining the at least one 2-dimensional image of the at least one user further comprises uploading the at least one 2-dimensional image of the at least one user to the first computer.

5. The method according to claim 4, wherein the at least one 2-dimensional image of the at least one user is uploadable to the first computer from an online website, a mobile phone, a digital camera, a handheld digital device, a portable digital device or a laser scanner.

6. The method according to claim 1, wherein the at least one 2-dimensional image of the at least one user includes at least one of a background and a foreground, and further wherein the at least one customized article includes one or more of the background and the foreground.

7. The method according to claim 1, wherein the converting the at least one 2-dimensional image of the at least one user to at least one 3-dimensional model of the at least one user is performed by a central processing unit that is located remote with respect to the first computer and the at least one user.

8. A method for customizing at least one original article and distributing at least one customized article, the method comprising at least:
obtaining, via a first computer, a first 2-dimensional image of at least one user comprising at least one of a first facial expression and a first facial view;
generating a plurality of second 2-dimensional images or 3-dimensional models of the at least one user based on the first 2-dimensional image of the at least one user, wherein the plurality of second 2-dimensional images or 3-dimensional models comprises at least one of a plurality of second facial expressions of the at least one user and a plurality of second facial views of the at least one user;
generating the at least one customized article by modifying the at least one original article to include at least one 2-dimensional image of the generated plurality of second 2-dimensional images or at least one 3-dimensional image of the generated plurality of 3-dimensional models; and
distributing the at least one customized article in digital form or in physical form.

9. The method according to claim 8, wherein the at least one customized article, in digital form, is selected from the group consisting of a digital story book or movie, a digital animation film, a digital video game, and a digital comic book, wherein the at least one customized article is displayable via a digital display associated with the first computer.

10. The method according to claim 8, wherein the at least one customized article, in physical form, is selected from the group consisting of a story book, a sticker book or album, an illustrated book, and a board game, wherein the at least one customized article is printable via a printer associated with the first computer.

11. The method according to claim 8, wherein the at least one customized article, in physical form, consists of a 3-dimensional printed article selected from the group consisting of a sculpture, a model and a vanity collectible.

12. The method according to claim 8, wherein the generating the plurality of 2-dimensional images or 3-dimensional models of the at least one user further comprises executing one or more computer programs or software that convert the first 2-dimensional image of the at least one user into the plurality of generated second 2-dimensional images or the plurality of generated 3-dimensional models.

13. The method according to claim 12, wherein the one or more computer programs or software are stored within the first computer, within a second computer in communication with the first computer via a digital network or within a database accessible via a server and the digital network.

14. The method according to claim 8, wherein the at least one customized item comprises one or more customized frames, wherein one or more original frames of the at least one original article are modified with the at least one 2-dimensional image of the generated plurality of second 2-dimensional images or the at least one 3-dimensional image of the generated plurality of 3-dimensional models to produce the one or more customized frames.

15. The method according to claim 14, wherein the one or more customized frames comprises one or more transferrable images.

16. The method according to claim 15, wherein the one or more transferrable images are one or more adhesive stickers and the at least one original article is a sticker book.

17. A non-transitory computer-readable storage medium storing one or more computer programs which enables a computer system, after the program is loaded into memory of the computer system, to execute a process for customizing at least one original article and distributing at least one customized article, the process comprising at least:
obtaining a first 2-dimensional image of a user via the computer system, wherein the first 2-dimensional image of the user comprises at least one of a first facial expression and a first facial view;
generating a plurality of second 2-dimensional images of the at least one user based on the first 2-dimensional image of the at least one user, wherein the plurality of second 2-dimensional images comprises at least one of a plurality of second facial expressions of the at least one user and a plurality of second facial views of the at least one user;
modifying one or more original frames of the at least one original article with one or more 2-dimensional images of the plurality of generated second 2-dimensional images to produce one or more customized frames, wherein the one or more customized frames comprises one or more transferrable images displaying the one or more 2-dimensional images of the generated plurality of generated second 2-dimensional images of the user; and
distributing the one or more customized frames via a printer associated with the computer system.

18. The non-transitory computer-readable storage medium according to claim 17, wherein the one or more transferrable images comprises one or more adhesive stickers and the original article is a sticker book

19. The non-transitory computer-readable storage medium according to claim 17, wherein the obtaining the first 2-dimensional image of the at least one user further comprises uploading the first 2-dimensional image of the at least one user to a first computer of the computer system.

20. The non-transitory computer-readable storage medium according to claim 17, wherein the plurality of generated second 2-dimensional images of the user are created from one or more 3-dimensional models of the at least one user that are based on the first 2-dimensional image of the at least one user.
